(19) United States
(12) Patent Application Publication
(10) Pub. No.: US 2019/0286575 A1
(43) Pub. Date: Sep. 19, 2019

(54) NETWORK INTERFACE DEVICE, INFORMATION PROCESSING DEVICE HAVING PLURAL NODES INCLUDING NETWORK INTERFACE DEVICE, AND METHOD FOR TRANSMITTING TRANSMISSION DATA BETWEEN NODES OF INFORMATION PROCESSING DEVICE

(71) Applicant: FUJITSU LIMITED, Kawasaki-shi (JP)

(72) Inventor: Shinya Hiramoto, Yokohama (JP)

(73) Assignee: FUJITSU LIMITED, Kawasaki-shi (JP)

(21) Appl. No.: 16/268,543

(22) Filed: Feb. 6, 2019

(30) Foreign Application Priority Data
Mar. 14, 2018 (JP) 2018-046159

(51) Int. Cl. G06F 12/1081; G06F 12/1027

(52) U.S. Cl. CPC G06F 12/1081; G06F 2212/68; G06F 2212/621; G06F 12/1027

(57) ABSTRACT

A network interface device includes a direct memory access control unit (DMA); an address translation buffer (TLB) that stores address translation entries including a part of entries in an address translation table stored in the main memory; and a control unit that controls processing in relation to a command from the processor. The control unit, upon receiving a first command, transmits first transmission data including first message and remote node pre-caching TLB to a remote computer node, and upon receiving a second command, transmits write transmission data. And the remote computer node, in response to the first transmission data, pre-caches a first address translation entry in the TLB, and in response to the write transmission data, translates the remote node virtual address into a remote node real address based on the first address translation entry, and writes the write data to the main memory at the remote node real address.

### CROSS-REFERENCE TO RELATED APPLICATION

This application is based upon and claims the benefit of priority of the prior Japanese Patent Application No. 2018-046159, filed on Mar. 14, 2018, the entire contents of which are incorporated herein by reference.

### FIELD

The present invention relates to a network interface device, an information processing device having a plurality of nodes that each includes the network interface device, and a method for transmitting transmission data between the nodes of the information processing device.

### BACKGROUND

A network interface device is provided in an information processing device such as a computer to control the transfer of data and so on to and from another computer over a network. The network interface device is realized by, for example, an integrated circuit chip on which an interface control circuit, a direct memory access control circuit, and so on are integrated.

In a high-performance computer (HPC) in which a plurality of computer nodes (referred to hereafter as computer nodes or simply nodes) are connected by a network, the plurality of computer nodes execute complex calculation processing and so on in parallel. In the parallel processing executed by the plurality of computer nodes, a first computer node stores calculated data in a second computer node, and the first computer node loads calculated data from the second computer node. To execute the former operation, the first computer node transfers a write packet, in which calculated write data are stored in the form of a message, to the second computer node. To execute the latter operation, the first computer node transfers a read packet to the second computer node, and the second computer node transfers a response packet, in which read calculated read data are stored in the form of a message, to the first computer node.

Meanwhile, a real address space is set individually in each of the plurality of computer nodes, while data reading and writing are performed in each computer node in a virtual address space of an application. Therefore, when the write data received by the second computer node are to be written to a main memory during the write packet processing described above, the second computer node translates the virtual address of the received write packet into a real address and then writes the write data in the write packet to the main memory. Further, when the read data received by the first computer node are to be written to the main memory during the read packet processing described above, the first computer node translates the virtual address of the received read packet into a real address and then writes the read data in the read packet at the real address of the main memory.

To translate the virtual address into a real address, the network interface of each node fetches from the main memory an address translation entry corresponding to an address translation in an address translation table and stores the address translation entry in an address translation buffer (a translation look-aside buffer: TLB) of the network interface.

According to the disclosure in Japanese Laid-open Patent Publication No. 2003-50743, when a processor of a first computer node issues a remote write command, a transmission device of the first computer node transmits a TLB pre-reading packet to a second computer node, and later transmits a write packet storing write data that is read from a main memory to the second computer node. According to this disclosure, the second computer node pre-reads the TLB in response to the TLB pre-reading packet, and then translates the virtual address of the received write packet into a real address by referring to the TLB.

A net work interface is disclosed in Patent Literature 1: Japanese Laid-open Patent Publication No. 2003-50743 and Patent Literature 2: Japanese Laid-open Patent Publication No. 2004-252838.

### SUMMARY

In Japanese Laid-open Patent Publication No. 2003-50743, however, in response to issuance of the remote write command, the transmission device of the first computer node transmits the TLB pre-reading packet to the second computer node first, and then transmits the write packet. Hence, the transmission device of the first computer node transmits two packets to the second computer node in response to the remote write command, leading to an increase in the amount of traffic on an internode network.

According to an aspect of the embodiments, a network interface device including: a direct memory access control unit (referred to hereafter as a DMA) that accesses a main memory without passing through a processor; an address translation buffer (referred to hereafter as a TLB) that stores address translation entries including a part of entries in an address translation table indicating correspondences between virtual addresses and real addresses, the address translation table being stored in the main memory; and a control unit that controls processing in relation to a command transmitted from the processor and processing in relation to received transmission data. The control unit, upon reception from the processor of a first command including a first message inquiring as to the possibility of responding to a request for either writing or reading and a remote node pre-caching TLB, transmits first transmission data that include the first message and the remote node pre-caching TLB to a remote computer node, and upon reception from the processor of a second command requesting either writing or reading, wherein the second command is issued in response to reception of first response data responded by the remote computer node to the first message and including a message indicating the possibility of responding to the request, and when the second command is a write request, transmits write transmission data that include a message including write data and a remote node virtual address both included in the second command to the remote computer node. And the remote computer node, in response to the first transmission data, reads a first address translation entry corresponding to the remote node pre-caching TLB from the main memory and pre-caches the read first address translation entry in the TLB, wherein the address translation entry includes a remote node real address of the main memory in the remote computer node corresponding to the remote node pre-caching TLB, and in response to the write transmission data, translates the remote node virtual address into a remote node real address on the basis of the first address translation entry, and writes the write data to the main memory on the basis of the remote node real address.

According to the first aspect, TLB pre-reading can be executed without increasing the amount of traffic on an internode network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view illustrating a configuration of an HPC according to an embodiment.

FIG. 2 is a view illustrating an example configuration of a computer node according to this embodiment.

FIG. 3 is a view illustrating examples of formats of commands issued by the processor according to this embodiment and messages relating thereto.

FIG. 4 is a view illustrating example formats of commands and packets in the case of a write packet.

FIG. 5 is a view illustrating the configuration of the network interface NW_IF in detail and a flow of main signals.

FIG. 6 is a sequence diagram illustrating operations performed by the respective processors and network interfaces of the local node and the remote node in the case of a write packet.

FIG. 7 is a sequence diagram illustrating operations performed by the respective processors and network interfaces of the local node and the remote node in the case of a write packet.

FIG. 8 is a view illustrating example formats of commands and packets in the case of a read packet.

FIG. 9 is a diagram illustrating operations performed by the respective processors and network interfaces of the local node and the remote node in the case of a read packet.

FIG. 10 is a diagram illustrating operations performed by the respective processors and network interfaces of the local node and the remote node in the case of a read packet.

FIG. 11 is a flowchart illustrating processing executed by the DMA control circuit according to the second embodiment.

FIG. 12 is a view illustrating configurations of nodes according to a third embodiment.

FIG. 13 is a view illustrating examples of the address translation table ATT and the TLB.

### DESCRIPTION OF EMBODIMENTS

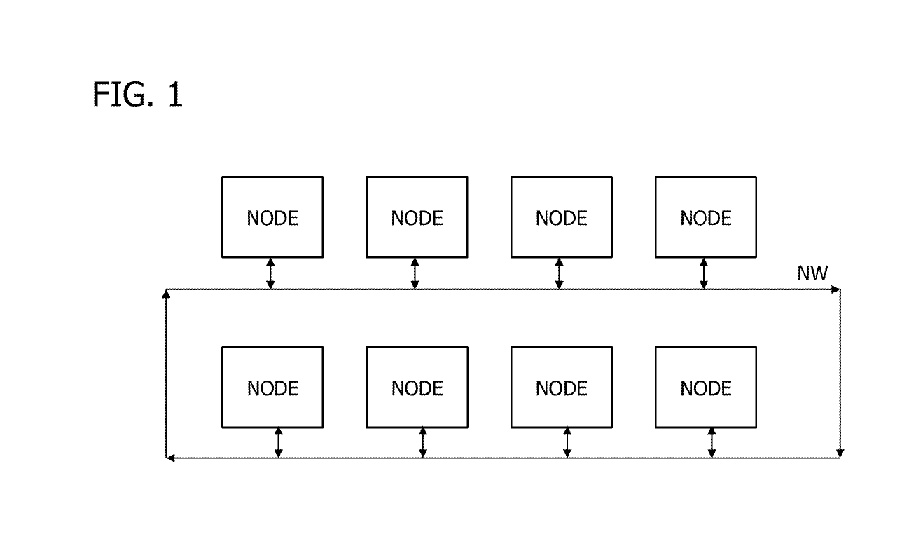

FIG. 1 is a schematic view illustrating a configuration of an HPC according to an embodiment. The HPC includes a plurality of computer nodes NODE and a network NW that is a communication network between the computer nodes. For example, the computer nodes are connected to the network NW via a router (not illustrated) provided on the network. In this type of HPC, the plurality of computer nodes execute calculation processing in parallel, whereupon a first computer node (a local node) transmits a calculation result to a second computer node (a remote node) over the network (calculation result writing), or conversely, the first computer node acquires a calculation result from the second computer node over the network (calculation result reading).

Further, a real address space in one computer node differs from the real address spaces in the other computer nodes. Accordingly, a virtual address used for memory access during a certain process is translated into a real address by each computer node, whereupon a main memory or the like in the node is accessed on the basis of the real address obtained as a translation result.

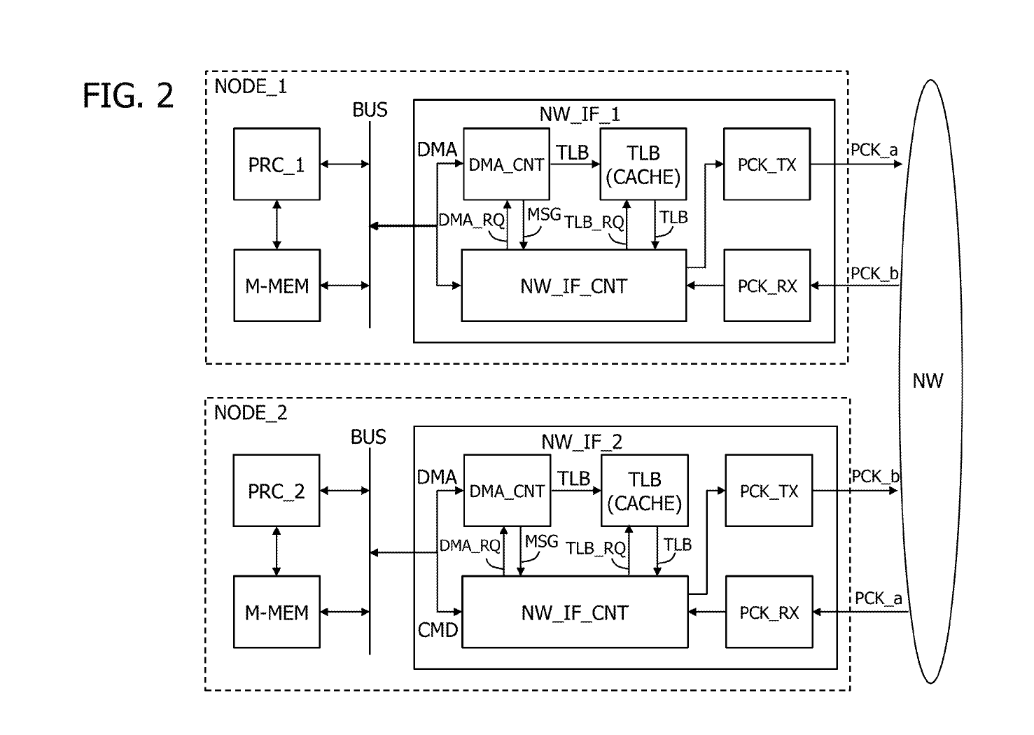

FIG. 2 is a view illustrating an example configuration of a computer node according to this embodiment. FIG. 2 depicts a first computer node NODE_1, a second computer node NODE_2, and the network NW.

The first computer node NODE_1 includes a processor PRC_1 such as a central processing unit (CPU), a main memory M_MEM such as a DRAM, an internal bus BUS, and a network interface NW_IF_1. The network interface is connected to the network in order to transmit and receive packets to and from other computer nodes. The second computer node NODE_2 is configured similarly.

Further, the network interfaces NW_IF_1, NW_IF_2 of the two nodes each include a network interface control circuit NW_IF_CNT, a packet transmission portion PCK_TX, a packet reception portion PCK_RX, a DMA control circuit DMA_CNT that performs direct memory access in relation to the main memory M_MEM, and an address translation buffer (a translation look-aside buffer (TLB)) for storing some of the entries in an address translation table. The address translation buffer TLB is a type of cache for storing some of the entries in an address translation table ATT in the main memory. The network interface is constituted by, for example, an integrated circuit device (a computer chip) having the network interface control circuit, the packet transmission portion, the packet reception portion, the DMA control circuit, and the TLB.

Operations for transmitting and receiving packets to and from nodes will now be described briefly. The processor PRC_# (#=1, 2) of each node issues a command to transmit a packet to another network interface NW_IF_#. In response to the command, the network interface executes the following processing. The following messages are constituted by communication text, communication code, data, or the like, for example.
(1) generating a packet that stores a message included in the command and transmitting the packet to a transmission destination node included in the command.
(2) obtaining a message in the main memory on the basis of a main memory address included in the command, generating a packet storing the obtained message and transmitting the packet to the transmission destination node in the command.

In the case of (1), the network interface stores the message in the command in a packet and transmits the packet, and therefore the latency of the message transmission processing is short.

In the case of (2), the network interface reads a message from the main memory by DMA on the basis of the address in the command, and therefore the message is subjected to DMA transfer by the DMA control circuit. Moreover, when the address in the command is a virtual address, the network interface reads a TLB entry for translating the virtual address into a real address may be read from the main memory by DMA and registered (cached) in the TLB. In the case of (2), therefore, the latency of the message transmission processing tends to be long.

Meanwhile, after receiving a packet, the network interface of the node executes the following processing.
(3) storing the message stored in the received packet in a reception buffer secured in advance in the main memory. Accordingly, the processor reads the received message from the reception buffer and executes needed processing.
(4) storing the message stored in the received packet at an address of the main memory stored in the received packet. The processor then executes corresponding processing on the received message.

In the case of (3), the reception buffer is secured in the main memory in advance, and therefore the capacity of the reception buffer is limited. Accordingly, the message capacity is also limited. The latency of the message reception processing, however, is short.

In the case of (4), the network interface writes the message in the received packet to the main memory by DMA on the basis of the address in the received packet. Further, when the address is a virtual address, the network interface reads a TLB for translating the virtual address into a real address from the main memory by DMA and registered (cached) in the TLB. In the case of (4), therefore, the latency of the message reception processing tends to be long.

As described above, in the network interface, the network interface control circuit NW_IF_CNT issues a DMA request DMA_RQ to the DMA control circuit DMA_CNT to read a message or a TLB entry in the main memory by DMA. The DMA control circuit transfers a message MSG read from the main memory to the network interface control circuit, or transfers a TLB entry read from the main memory to the TLB.

Furthermore, the network interface control circuit issues a TLB request TLB_RQ to the TLB to translate a virtual address into a real address, and in the case of a cache hit, obtains a real address corresponding to the virtual address from the TLB. In the case of a cache miss, the network interface control circuit issues a TLB DMA request DMA_RQ to the DMA control circuit to register the TLB entry of the virtual address that is to be translated in the TLB.

Note that the packet is not limited to a simple information format, and the transmission/reception subject is not limited to a packet. Instead, a frame, simple data, or the like may be used. Hereafter, a packet may also be referred to as transmission data.

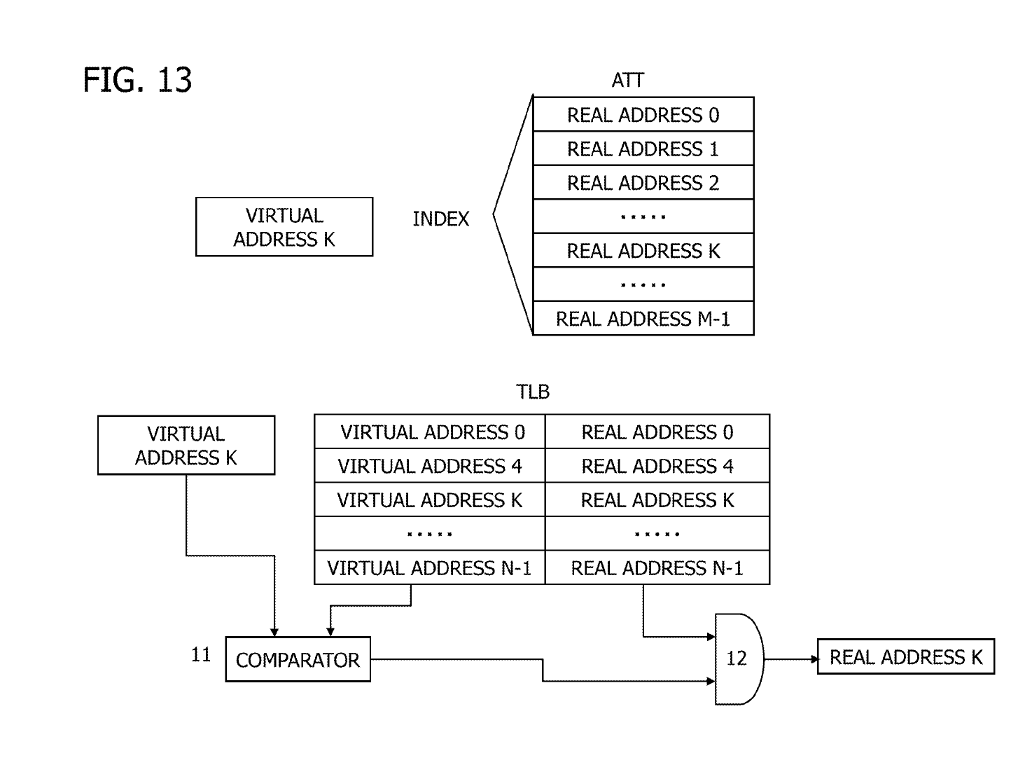

FIG. 13 is a view illustrating examples of the address translation table ATT and the TLB. The address translation table ATT in the main memory is a correspondence table that indicates correspondences between all virtual addresses and real addresses. Note, however, that the virtual addresses are indexes and all real addresses 0 to M−1 are registered corresponding to the indexes. In the TLB, meanwhile, some of the entries in the ATT are registered, and each TLB entry includes a real address and a virtual address corresponding thereto.

In processing for registering a TLB entry in the TLB, a real address K is read from the address translation table ATT in the main memory using a virtual address K as an index, whereupon the virtual address K and the real address K are registered in the TLB as a TLB entry. When no entry space is available in the TLB, an old TLB entry is discarded and the new TLB entry is registered.

When the virtual address K is to be translated into the real address K by the TLB, the TLB entries are read in sequence and the real address K corresponding to the virtual address that matches the translation subject virtual address K is extracted by a comparator 11 and an AND gate 12. When a virtual address that matches the translation subject virtual address exists in the TLB, a cache hit is obtained, and when a matching virtual address does not exist, a cache miss is obtained. In the case of a cache miss, a TLB entry is read from the ATT in the main memory and registered in the TLB.

The packet transmission processing (1) and (2) and reception processing (3) and (4) described above involve DMA processing for reading a message from the main memory by DMA and writing a message to the main memory by DMA, and DMA processing for reading an address translation entry from the address translation table ATT in the main memory by DMA in order to translate a virtual address into a real address. This type of DMA processing executed in relation to the main memory typically has a long latency and therefore causes an increase in the latency of the transmission processing and reception processing.

### First Embodiment

### Formats of Commands and Messages

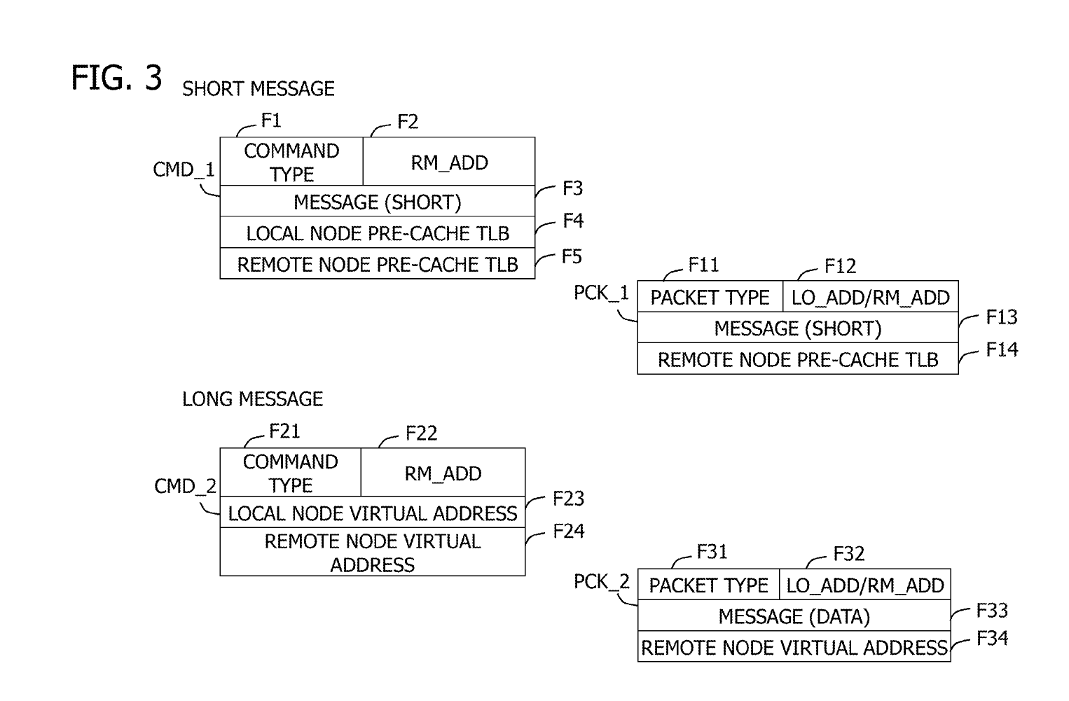

FIG. 3 is a view illustrating examples of formats of commands issued by the processor according to this embodiment and messages relating thereto.

First Command and First Packet

According to this embodiment, a first command CMD_1 issued by the processor is provided with a message field F3 for inquiring as to the possibility of responding to a write or read request, a local node pre-caching TLB field F4, and a remote node pre-cache TLB field F5. The inquiry message has a short bit length. The first command also includes a field F1 indicating the type of command and a field F2 indicating a remote node address RM_ADD of the message transmission destination.

A message having a short enough data length to be storable in a reception buffer, for example transmission text, a transmission code, or the like, is stored in the message field F3 of the first command.

The local node pre-cache TLB field F4 is a field for issuing a request to the local node that is the transmission source node to execute pre-caching (TLB pre-caching hereafter) of an address translation entry (a TLB entry hereafter). Information such as the index of the TLB entry in the address translation table ATT that is used for TLB pre-caching is stored in the local node pre-caching TLB field F4. On the basis of the index, the network interface control circuit of the local node reads the TLB entry corresponding to the index of the ATT in the main memory of the local node by DMA, and registers the read TLB entry in the TLB.

The remote node pre-caching TLB field F5 is a field for issuing a TLB pre-caching request to the remote node that is the transmission destination node, and as described above, information such as the index of the TLB entry is stored therein. On the basis of the index, the network interface control circuit of the remote node reads the TLB entry corresponding to the index of the ATT in the main memory by DMA.

Meanwhile, a first packet PCK_1 transmitted by the network interface control circuit in response to the first command CMD_1 includes a packet type field F11, a field F12 for a local node address LO_ADD of the packet transmission source/a remote node address LM_ADD of the packet transmission destination, a message field F13, and a remote pre-caching TLB field F14.

The remote node pre-caching TLB included in the first command is stored in the remote pre-caching TLB field F14. On the basis of the index thereof, the network interface control circuit of the remote node reads the TLB entry corresponding to the index of the ATT in the main memory of the remote node by DMA, and registers the read TLB entry in the TLB.

Second Command and Second Packet

When, in response to the inquiry of the first command CMD_1, a response packet storing the message “response to request is possible” is received from the remote node that is the transmission destination of the packet, the processor of the local node issues a second command CMD_2 requesting either reading or writing.

The format of the second command CMD_2 includes a local node virtual address field F23 and a remote node virtual address field F24 in addition to fields F21, F22 for the command type and the remote node address RM_ADD.

Writing

When the second command CMD_2 is a write command, the virtual address of the local node, at which the content of the message to be transferred by the packet is stored, is stored in the local node virtual address field F23.

The network interface control circuit of the local node translates the virtual address into a real address on the basis of the TLB entry that is pre-cached by a local node pre-caching TLB in the first command CMD_1, and reads the content of the message from the main memory of the local node on the basis of the real address. The message is constituted by data or the like of a volume that is too large (a bit length that is too long) to be storable in the reception buffer.

The network interface control circuit then generates a second packet PCK_2 storing the read message and transmits the second packet PCK_2 to the remote node.

The format of the second packet PCK_2 includes a read message field F33 and a remote node virtual address field F34 in addition to a field F31 for the packet type and a field F32 for the local node address LO_ADD and the remote node address RM_ADD.

After receiving the second packet PCK_2, the network interface control circuit of the remote node translates the remote node virtual address included in the second packet PCK_2 into a real address on the basis of the TLB entry that was pre-cached in the TLB upon reception of the first packet PCK_1, and writes the message (data) included in the second packet to the real address in the main memory.

Reading

When, on the other hand, the second command CMD_2 is a read command, the virtual address of the local node, at which the message (data) included in the response packet transmitted from the remote node in response to the second packet PCK_2 is stored, is stored in the local node virtual address field F23.

The network interface control circuit of the local node then generates the second packet PCK_2, in which the virtual address of the read destination in the remote node is stored but the message is not stored, and transmits the generated packet to the remote node.

After receiving the second packet PCK_2, the network interface control circuit of the remote node translates the remote node virtual address included in the second packet PCK_2 into a real address on the basis of the TLB entry that was pre-cached in the TLB upon reception of the first packet PCK_1, and reads the message (data) on the basis of the real address in the main memory. The network interface control circuit of the remote node then transmits a response packet storing the read message (data) to the local node.

After receiving the response packet, the network interface control circuit of the local node translates the local node virtual address in the second command into a real address on the basis of the TLB entry pre-cached in the local node pre-caching TLB of the first command, and writes the message (data) included in the response packet to the main memory.

Although not illustrated in the figures, in each of the packets described above, a packet ID is stored in a header, and in the response packets, the packet ID of the response subject packet is also stored.

The operations performed respectively in the case of a write packet and a read packet will now be described in detail.

Operations in the Case of a Write Packet

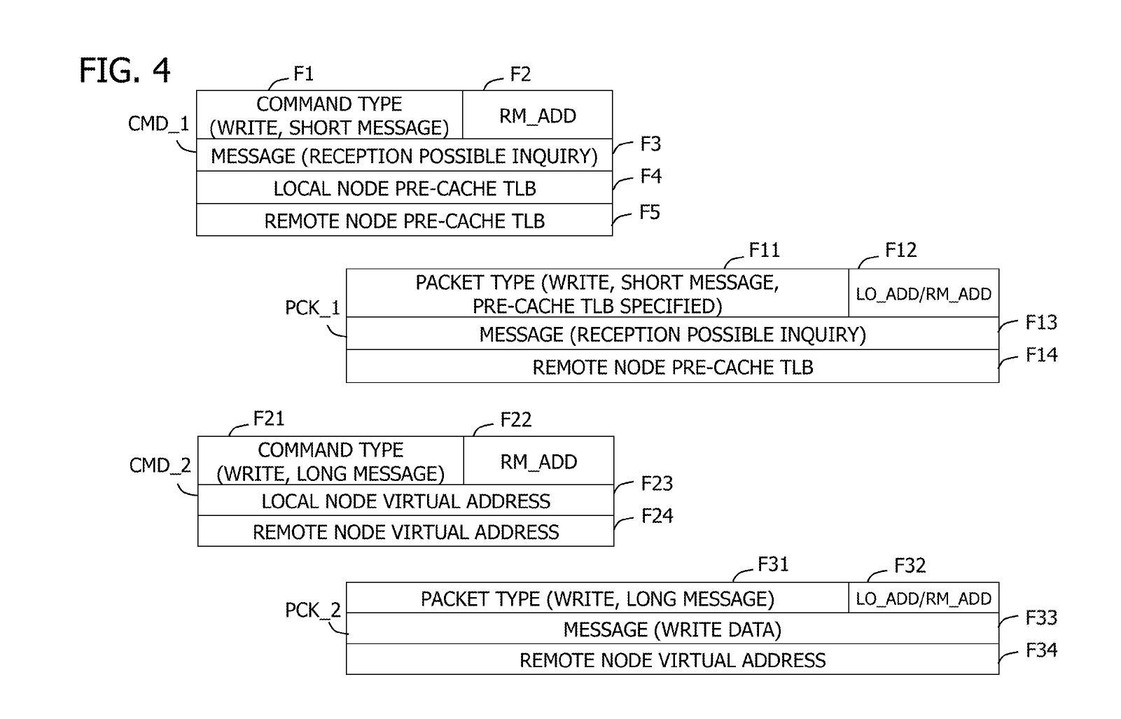

FIG. 4 is a view illustrating example formats of commands and packets in the case of a write packet. The first command CMD_1 and the second command CMD_2 illustrated in FIG. 4 have identical formats to the first command CMD_1 and the second command CMD_2 illustrated in FIG. 3.

Note, however, that “write, short message” is stored in the command type field F1 of the first command CMD_1 in FIG. 4, and “reception possible inquiry” is stored in the message field F3 in the form of communication text or communication code. Thus, the first command CMD_1 is a command to transmit an inquiry packet in relation to a write packet. Further, “write, long message” is stored in the command type field F21 of the second command CMD_2 in FIG. 4, and thus the second command CMD_2 is a command to transmit a write packet.

Meanwhile, the first packet PCK_1 and the second packet PCK_2 illustrated in FIG. 4 have identical formats to the first packet PCK_1 and the second packet PCK_2 illustrated in FIG. 3.

Note, however, that “write, short message, pre-caching TLB specified” is stored in the packet type field F11 of the first packet PCK_1 in FIG. 4, and “reception possible inquiry” is stored in the message field F13. Further, “write, long message” is stored in the packet type field F31 of the second packet PCK_2, and “data” is stored in the message field F34.

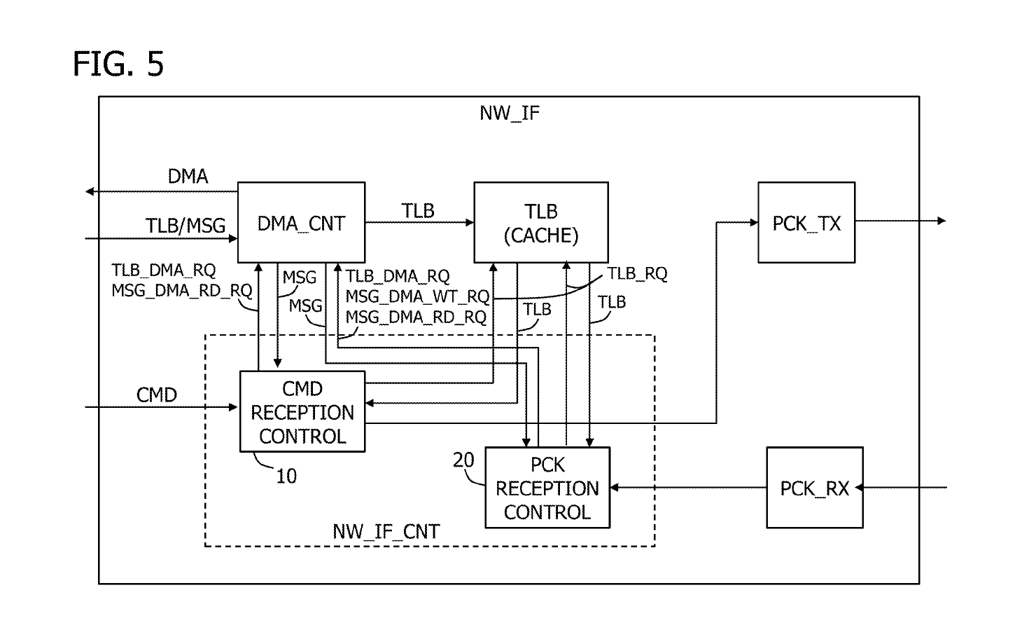

FIG. 5 is a view illustrating the configuration of the network interface NW_IF in detail and a flow of main signals. In FIG. 5, the network interface control circuit NW_IF_CNT includes a command reception control circuit 10 for receiving a command CMD transmitted from the processor and executing needed processing, and a packet reception control circuit 20 for executing processing on a packet received by the packet reception portion PCK_RX.

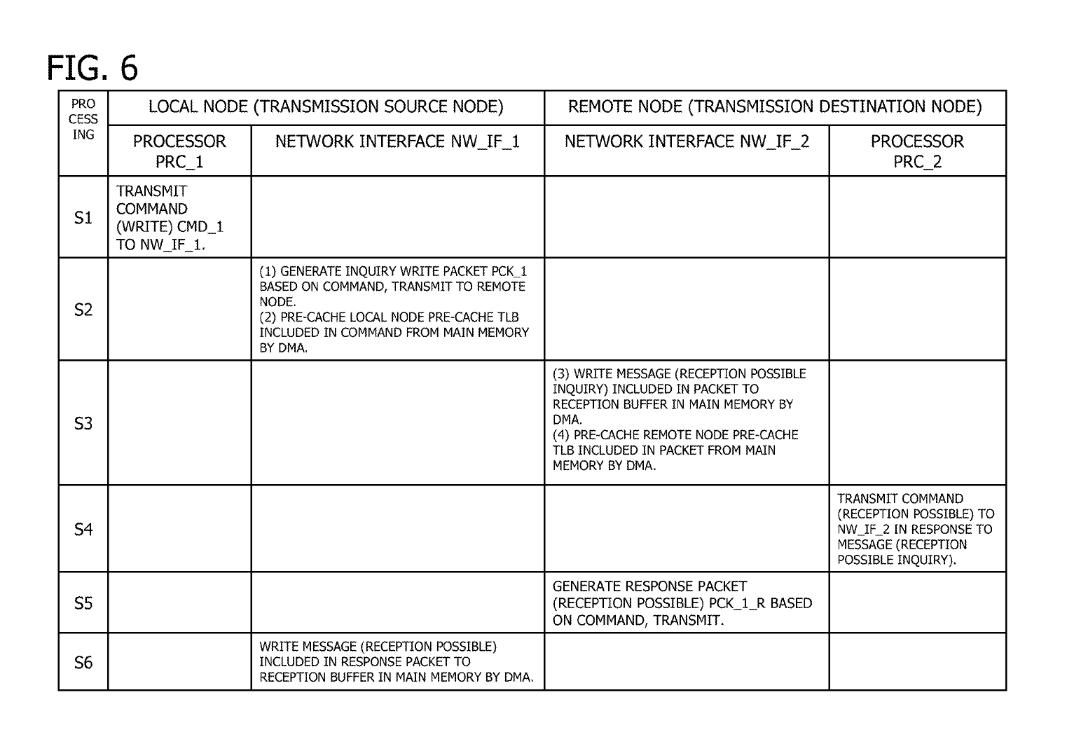

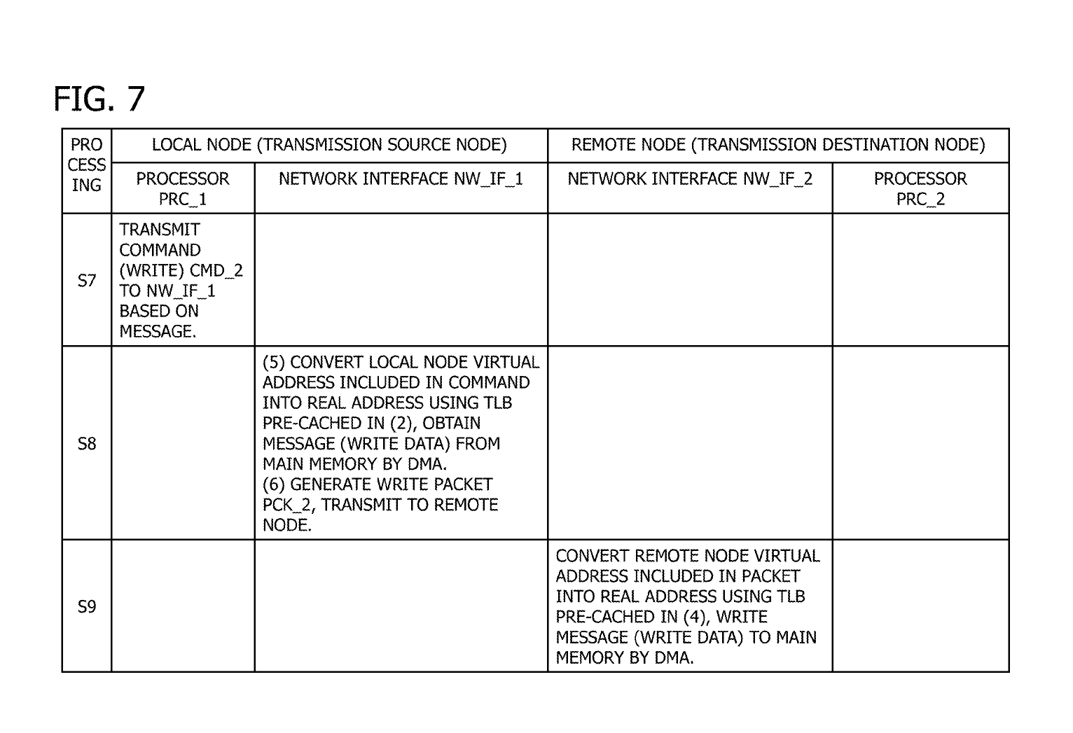

FIGS. 6 and 7 are sequence diagrams illustrating operations performed by the respective processors and network interfaces of the local node and the remote node in the case of a write packet. In FIG. 6, a vertical axis corresponds to a temporal axis. Referring to FIGS. 4, 5, 6, and 7, operations executed when the local node writes a message to the remote node will now be described.

Processing in Local Node NODE_1

S1: As illustrated in FIG. 6, first, the processor PRC_1 of the local node NODE_1 transmits the first command CMD_1 illustrated in FIG. 4 to the network interface NW_IF_1 (S1). As illustrated in FIG. 4, in the first command, “write, short message” is stored in the command type field F1 and “reception possible inquiry” is stored as a message in the message field F3. Moreover, the local node pre-cache TLB and the remote node pre-cache TLB are also stored. Here, the “reception possible inquiry” message is an inquiry as to whether or not the remote node that is the transmission destination of the packet is ready to receive write data and write the received data to the main memory.

S2: The command reception control circuit 10 of the network interface NW_IF_1 of the local node (1) generates, in response to the first command CMD_1, an inquiry write packet PCK_2 in which the “reception possible inquiry” message of the first command is stored in the message field F13, and transmits the generated packet to the remote node via the packet transmission portion PCK_TX (S2). As illustrated in FIG. 4, the “reception possible inquiry” message and the remote node pre-cache TLB are stored in the inquiry write packet PCK_2 in addition to the packet type, and the local node address LO_ADD/the remote node address RM_ADD.

Further, the command reception control circuit 10 of the network interface NW_IF_1 of the local node (2) reads, on the basis of the information (the index of the address translation table ATT) relating to the local node pre-cache TLB in the first command CMD_1, the TLB entry corresponding to the index of the address translation table ATT in the main memory M_MEM by DMA, and issues a TLB pre-caching request TLB_DMA_RQ to the DMA control circuit DMA_CNT to register the read TLB entry in the TLB (S2). In response to the TLB pre-caching request, the TLB entry used to translate the virtual address of the write data in the main memory into a real address is pre-cached in the TLB.

Processing in Remote Node NODE_2

S3: In response to reception of the inquiry write packet PCK_2 that is the second packet, the packet reception control circuit 20 of the network interface NW_IF_2 of the remote node NODE_2 (3) issues a message DMA write request MSG_DMA_WT_RQ to the DMA control circuit to write the “reception possible inquiry” message included in the packet PCK_2 to a reception buffer secured in advance in the main memory by DMA (S3). As a result, the processor PRC_2 is able to read the content of the message in the packet PCK_2.

Further, the packet reception control circuit 20 of the network interface NW_IF_2 of the remote node NODE_2 (4) reads, on the basis of the information relating to the remote node pre-cache TLB in the packet PCK_2, the entry corresponding to the index in the address translation table ATT in the main memory M_MEM by DMA, and issues a TLB pre-caching request TLB_DMA_RQ to the DMA control circuit DMA_CNT to register the read entry in the TLB (S3). In response to the TLB pre-caching request, the TLB entry used to translate the virtual address of the write data in the main memory into a real address is pre-cached in the TLB.

S4: The processor PRC_2 of the remote node determines, in relation to the “reception possible inquiry” message in the reception buffer, whether or not processing for receiving a write packet is possible, and when the processing is possible, the processor PRC_2 transmits a command to the network interface NW_IF_2 to transmit a response packet storing a message indicating that reception is possible (S4). This command is not illustrated in the figures, but includes, for example, the command type (a response to a write inquiry), the transmission destination node address of the response packet (the address of the local node NODE_1), and the message “reception possible”.

S5: In response to this command, the command reception control circuit 10 of the network interface NW_IF_2 of the remote node generates a response packet PCK_1_R storing the “reception possible” message, and transmits the generated response packet PCK_1_R to the local node from the packet transmission portion PCK_TX (S5).

Processing in Local Node NODE_1

S6: In response to reception of the response packet PCK_1_R from the remote node, the packet reception control circuit 20 of the network interface of the local node writes the “reception possible” message included in the response packet to the reception buffer secured in advance in the main memory by DMA (S6).

S7: As illustrated in FIG. 7, next, on the basis of the “reception possible” message in the response packet, the processor PRC_1 of the local node transmits the second command CMD_2 to the network interface NW_IF_1 (S7). As illustrated in FIG. 4, the command type “write, long message”, the remote node address RM_ADD, and the respective virtual addresses of the local node and the remote node are stored in the second command CMD_2.

S8: In response to the second command, the command reception control circuit 10 of the network interface (5) issues a TLB request TLB_RQ to the TLB and obtains the real address corresponding to the local node virtual address included in the second command on the basis of the TLB entry that was pre-cached in (2) of S2. Further, the command reception control circuit 10 issues a request MSG_DMA_RQ to the DMA control circuit DMA_CNT to read the message at the obtained real address in the main memory by DMA, and thereby obtains the message (write data) (S8). The second command is a command to transmit a long message, but since the TLB entry is pre-cached in the TLB in (2) of S2, the command reception control circuit 10 can complete translation of the local node virtual address into a real address quickly and then read the message in the main memory.

Furthermore, the command reception control circuit 10 (6) generates a write packet PCK_2 storing the message (write data) obtained by DMA, and transmits the generated write packet PCK_2 to the remote node via the packet transmission portion PCK_TX (S8). As illustrated in FIG. 4, the remote node virtual address included in the second command is stored in the write packet PCK_2 that is the second packet in addition to the message (write data).

Processing in Remote Node NODE_2

S9: The packet reception control circuit 20 of the network interface NW_IF_2 of the remote node issues a TLB request TLB_RQ to the TLB requesting, on the basis of the TLB entry pre-cached in (4) of S3, the real address that corresponds to the remote node virtual address included in the write packet. In response, the packet reception control circuit 20 obtains the real address that corresponds to the remote node virtual address on the basis of the pre-cached TLB entry, and issues a request MSG_DMA_WT_RQ to the DMA control circuit DMA_CNT to write the message (write data) included in the write packet to the main memory on the basis of the real address by DMA (S9). As a result, the message (write data) is written to the main memory.

Likewise here, the TLB entry is pre-cached in (4) of S3, and therefore the packet reception control circuit 20 can translate the remote node virtual address into a real address quickly, enabling a reduction in the latency of the write processing.

In the series of processes described above, the remote node pre-caching TLB is stored in the first packet PCK_1 so as to have the remote node pre-cache a TLB entry in advance, and the remote node virtual address of the write destination is stored in the second packet PCK_2. Accordingly, the local node transmits the first and second packets for the write processing to the remote node, and the remote node executes TLB pre-caching in response to the first packet, and as a result, the DMA processing executed by the remote node in relation to the write data included in the second packet is increased in speed. Hence, TLB pre-caching can be performed in the remote node without increasing the amount of traffic on the network. In Japanese Laid-open Patent Publication No. 2003-50743, in contrast, two packets, namely the pre-reading packet and the write packet, are transmitted in response to the second command.

In the write packet transmission processing described above, TLB pre-caching does not have to be performed in the local node on the basis of the first command, and instead, for example, a third command commanding TLB pre-caching may be issued between the first command and the second command. Note, however, that by storing the remote node pre-caching TLB in the first packet and having the remote node execute TLB pre-caching in advance, the latency of the write packet processing can be shortened.

Operations in the Case of a Read Packet

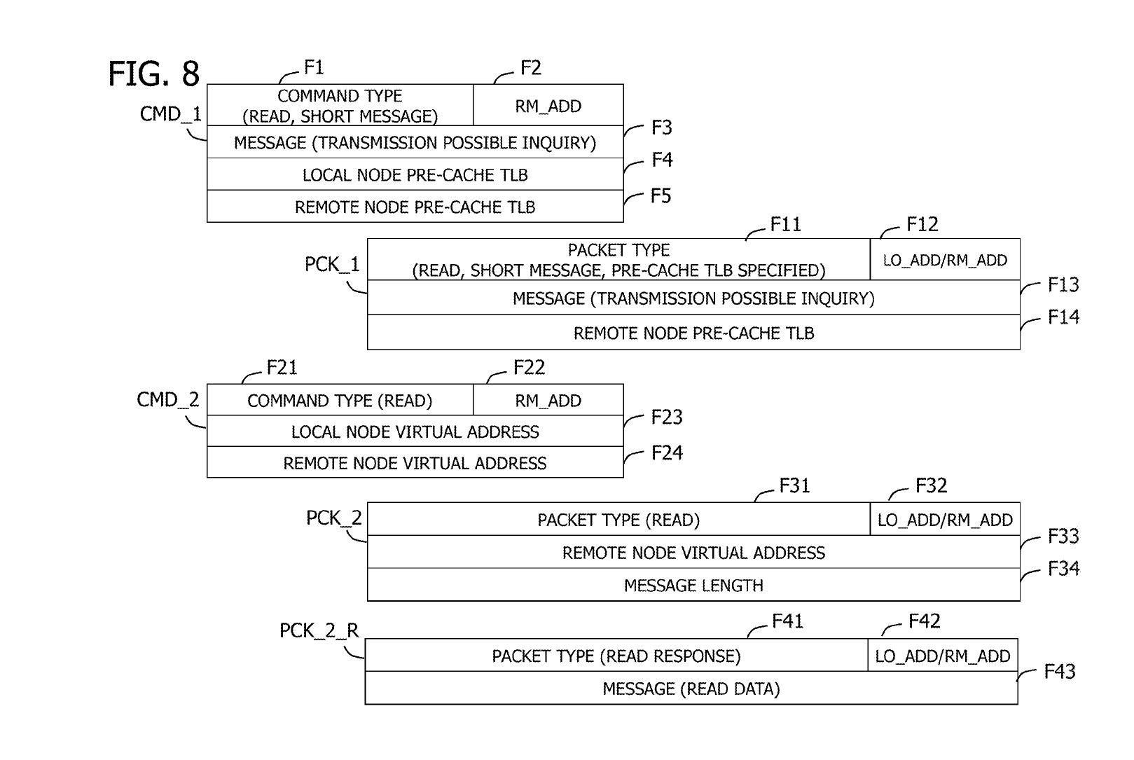

FIG. 8 is a view illustrating example formats of commands and packets in the case of a read packet. The first command CMD_1 and the second command CMD_2 illustrated in FIG. 8 have identical formats to the first command CMD_1 and the second command CMD_2 illustrated in FIG. 3.

Note, however, that “read, short message” is stored in the command type field F1 of the first command CMD_1 in FIG. 8, and “transmission possible inquiry” is stored in the message field F3 in the form of communication text or communication code. Thus, the first command CMD_1 is a command to transmit an inquiry packet in relation to reading. Further, “read” is stored in the command type field F21 of the second command CMD_2 in FIG. 8, and thus the second command CMD_2 is a command to transmit a read packet.

Meanwhile, the format of the first packet PCK_1 in FIG. 8 is identical to the format of the first packet PCK_1 in FIG. 3. The format of the second packet PCK_2 differs from the format of the second packet in FIG. 3 in having a remote node virtual address field F33 and a message length (data length) field F34.

Further, a response packet PCK_2_R to the second packet PCK_2, not illustrated in FIG. 3, includes a packet type field F41 in which “read response” is stored, a field F42 for the local node address and the remote node address, and a message field F43. The message in the response packet is constituted by the read data read by the remote node.

Note that “read, short message, pre-caching TLB specified” is stored in the packet type field F11 of the first packet PCK_1 in FIG. 8, and “transmission possible inquiry” is stored in the message field F13. Further, “read” is stored in the packet type field F31 of the second packet PCK_2.

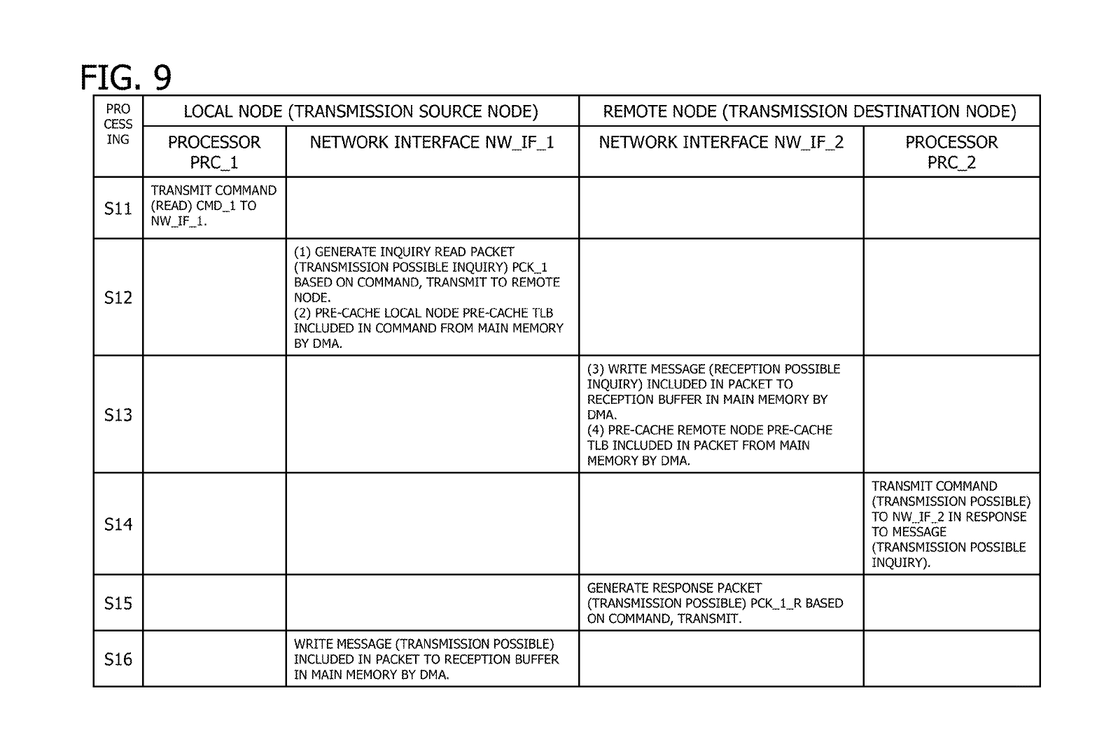

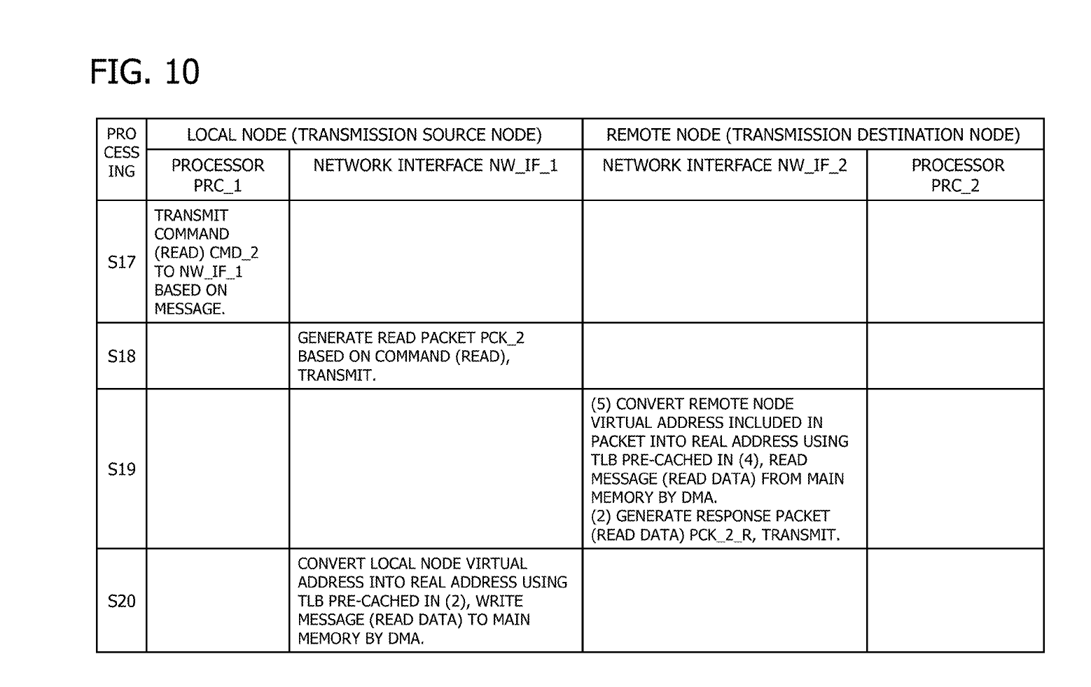

FIGS. 9 and 10 are sequence diagrams illustrating operations performed by the respective processors and network interfaces of the local node and the remote node in the case of a read packet. Likewise in FIGS. 9 and 10, the vertical axis corresponds to a temporal axis. Referring to FIGS. 5, 8, 9, and 10, operations executed when the local node reads a message from the remote node will now be described. The main differences from the write packet will also be described.

Processing in Local Node NODE_1

S11: In FIG. 9, the processor PRC_1 of the local node NODE_1 transmits the first command CMD_1 to the network interface NW_IF_1 (S11). As illustrated in FIG. 8, in the first command CMD_1, the content of the message is “transmission possible inquiry”, which differs from the “reception possible inquiry” message of the write packet. “Transmission possible inquiry” is an inquiry as to whether or not the remote node that is the transmission destination of the read packet is capable of transmitting read data to the local node.

S12: In response to the first command CMD_1, the network interface NW_IF_1 (1) generates an inquiry read packet PCK_1 as the first packet and transmits the generated inquiry read packet PCK_1 to the remote node NODE_2 (S12). As illustrated in FIG. 8, the content of the message in the first packet PCK_1 is “transmission possible inquiry”. Otherwise, the inquiry read packet PCK_1 is identical to the write packet PCK_1 of FIG. 4.

Further, in response to the first command, the network interface NW_IF_1 (2) accesses the main memory by DMA on the basis of the index included in the local node pre-caching TLB field of the command in order to pre-cache the TLB entry that will be used to write the read data to the main memory in the TLB (S12).

As described above, the processing executed in the local node NODE_1 is substantially identical to the processing executed in relation to the write packet, illustrated in FIG. 6, and differs only in the message content.

Processing in Remote Node NODE_2

S13: In response to reception of the first packet PCK_1, the network interface NW_IF_2 of the remote node (3) writes the “transmission possible inquiry” message of the packet to the reception buffer of the main memory by DMA (S13). Further, the network interface NW_IF_2 (4) pre-caches the TLB entry that will be used to read the read data from the main memory to the TLB on the basis of the remote node pre-caching TLB included in the second packet PCK_2 (S13). This processing is substantially identical to the processing S3 executed in the case of the write packet, illustrated in FIG. 6.

S14: In response to the received “transmission possible inquiry” message, the processor PRC_2 of the remote node checks whether or not it is possible to read and transmit the read data, and when it is possible, the processor PRC_2 transmits a command (not illustrated) to the network interface NW_IF_2 requesting transmission of the message “transmission possible” (S14). This command is not illustrated in the figures, but includes, for example, the command type (a response to a read inquiry), the transmission destination node address of the response packet (the address of the local node NODE_1), and the message “transmission possible”.

S15: In response to this command, the command reception control circuit 10 of the network interface NW_IF_2 of the remote node generates a response packet storing the “transmission possible” message and transmits the generated response packet to the local node from the packet transmission portion PCK_TX (S15). This processing is likewise substantially identical to the processing of S4 and S5 executed in the case of the write packet, as illustrated in FIG. 6.

Processing in Local Node NODE_1

S16: In response to the response packet, the network interface NW_IF_1 writes the “transmission possible” message included in the packet to the reception buffer of the main memory by DMA (S16).

S17: As illustrated in FIG. 10, on the basis of the message in the reception buffer, the processor PRC_1 transmits the second command CMD_2 requesting transmission of a read packet to the network interface NW_IF_1 (S17).

In response to the second command CMD_2, the network interface NW_IF_1 generates a read packet PCK_2 as the second packet and transmits the generated read packet PCK_2 to the remote node (S18). As illustrated in FIG. 8, the second packet PCK_2 does not have a message field, but includes the remote node virtual address field F33 and the message length field F34.

Processing in Remote Node

S19: In response to reception of the second packet PCK_2, the network interface NW_IF_2 of the remote node (5) translates the remote node virtual address included in the packet into a real address using the TLB entry that was pre-cached in (4) of the processing S14 and, on the basis of the real address, reads the read data in the main memory by DMA (S19). Since the TLB entry is pre-cached, this processing is completed quickly.

Further, the network interface NW_IF_2 (6) generates the response packet PCK_2_R in response to the second packet that is the read packet, and transmits the generated response packet PCK_2_R to the local node NODE_1 (S19). As illustrated in FIG. 8, the read data are stored in the response packet PCK_2_R as the message.

Processing in Local Node

S20: In response to reception of the response packet PCK_2_R to the second packet, the network interface NW_IF_1 of the local node translates the local node virtual address into a real address using the TLB entry pre-cached in (2) of the processing S12 and, on the basis of the real address, writes the read data that is the message to the main memory by DMA (S20). Likewise with regard to this processing, since the TLB entry is pre-cached, the read data write processing is completed quickly.

In the read packet transmission processing described above, TLB pre-caching does not have to be performed in the local node on the basis of the first command, and instead, for example, a third command commanding TLB pre-caching may be issued between the first command and the second command.

Note, however, that by storing the remote node pre-caching TLB in the first packet and having the remote node execute TLB pre-caching in advance, the latency of the read packet processing can be shortened. Further, the packets exchanged over the network are the first and second packets and the response packet to the second packet, and a pre-reading packet does not have to be added for the purpose of TLB pre-caching in the remote node. As a result, an increase in the amount of traffic on the network does not occur.

In Japanese Laid-open Patent Publication No. 2003-50743, in contrast, a pre-reading packet and a read packet are transmitted to the remote node in response to the second command.

### Second Embodiment

In the first embodiment, in the case of the write packet, during the processing S3 in FIG. 6, the remote node (3) writes the message included in the packet to the reception buffer of the main memory by DMA and (4) reads the TLB entry from the main memory by DMA on the basis of the remote node pre-caching TLB included in the packet. Similarly, in the case of the read packet, during the processing S13 of FIG. 9, the remote node writes the message to the main memory and reads the TLB entry by DMA.

However, the TLB entry read by DMA and pre-cached in the TLB is used for address translation during the subsequent processing. Therefore, to shorten the overall latency of the write processing and read processing, it is preferable to reduce the priority of the DMA processing for TLB pre-caching and increase the priority of the processing for writing the message included in the received first packet to the reception buffer of the main memory by DMA.

Accordingly, in the second embodiment, the DMA control circuit DMA_CNT of the network interface is improved so that the DMA processing executed on the message is prioritized over the DMA processing executed on the TLB entry.

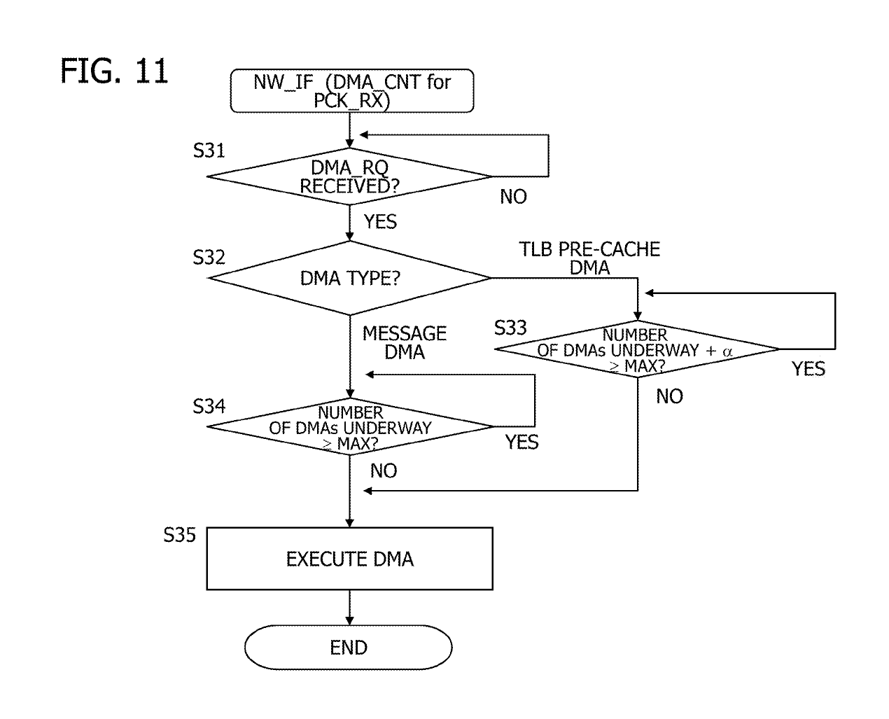

FIG. 11 is a flowchart illustrating processing executed by the DMA control circuit according to the second embodiment. As illustrated in FIG. 5, the DMA control circuit DMA_CNT accesses the main memory by DMA upon reception of a DMA request. In this case, the DMA processing is executed after securing the circuit resources used in the DMA processing, for example a DMA request buffer for storing the DMA request, a DMA reception buffer for temporarily storing the data read by DMA, and so on. These resources are limited in number, and therefore the DMA control circuit determines, in response to the received DMA request, whether or not the resources used in the DMA processing can be secured. When the resources can be secured, DMA is executed, and when the resources are not able to be secured, the DMA control circuit waits until the DMA request can be secured.

In the second embodiment, therefore, a difference in priority is established between the DMA processing for TLB pre-caching and the DMA processing for message writing in the processing for determining whether or not resources can be secured.

More specifically, upon reception of a DMA request DMA_RQ (YES in S31), the DMA control circuit determines the type of the DMA request (S32). When the DMA request is a request for TLB pre-caching, the DMA control circuit determines whether or not the number of DMAs currently underway+α has reached a maximum value of the amount of resources (S33). When the determination is negative, the DMA request is executed (S35), and when the determination is affirmative, the DMA control circuit refrains from executing the DMA request until the determination becomes negative (NO in S33). In other words, the DMA control circuit executes the DMA request when the remaining amount of usable resources is larger than a, and when the remaining amount of usable resources is not larger than a, holds the DMA request on standby until the amount becomes larger than a.

When the DMA request is a message request, the DMA control circuit determines whether or not the number of DMAs currently underway has reached the maximum value of the amount of resources (S34). When the determination is negative, the DMA request is executed (S35), and when the determination is affirmative, the DMA control circuit refrains from executing the DMA request until the determination becomes negative (NO in S34). Here, the above mentioned a is the number of resources used to execute DMA processing in relation to a message having a higher priority. The message in this case is a short message, and therefore “1” may be set as the number of resources used for the DMA processing in relation to the message. Hence, α=1.

According to the processing of the DMA control circuit described above, when DMA processing for TLB pre-caching and DMA processing for a message are executed consecutively, at least α resources always remain in the DMA control circuit even after executing the DMA processing for TLB pre-caching, and therefore the DMA processing for the message can be executed reliably. Hence, DMA processing executed in relation to a message has a higher priority than DMA processing for TLB pre-caching.

### Third Embodiment

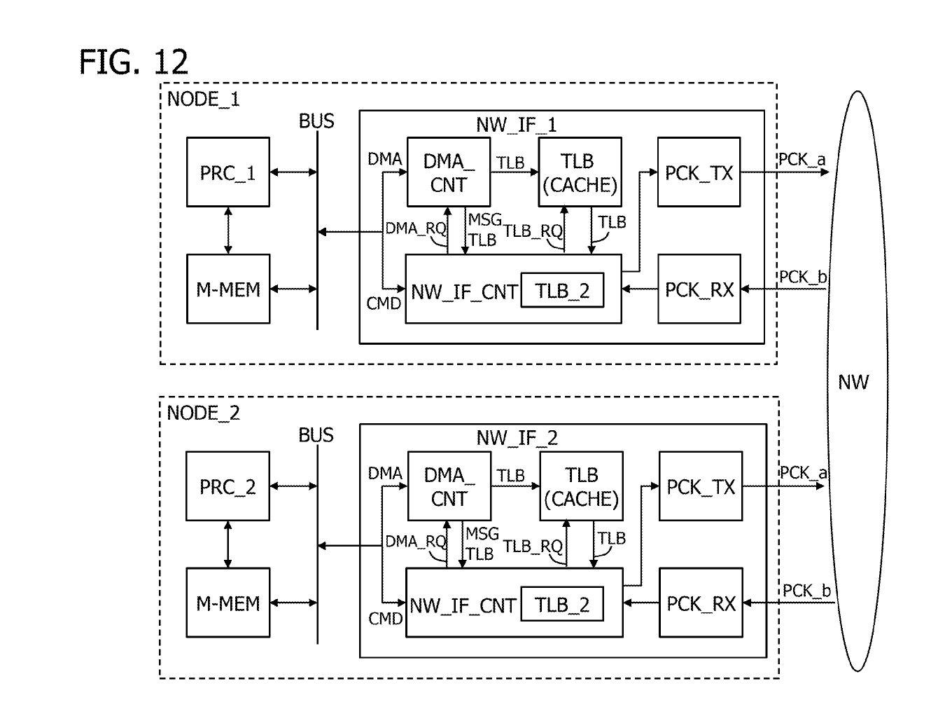

FIG. 12 is a view illustrating configurations of nodes according to a third embodiment. The TLB is a type of cache for storing a plurality of TLB entries constituting some of the TLB entries in the address translation table ATT in the main memory. Hence, when DMA processing is executed, search processing is executed to detect the TLB entry needed for address translation in the TLB, and as a result, the latency of the processing increases.

In the third embodiment, therefore, a TLB storage portion TLB_2 having a smaller capacity than the TLB is provided in the network interface control circuit NW_IF_CNT. The TLB storage portion TLB_2 stores a smaller number of entries than the TLB, and therefore the circuit scale of the TLB storage portion is smaller than that of the TLB.

As illustrated in FIG. 12, when, in response to a DMA request DMA_RQ for TLB pre-caching, the DMA control circuit DMA_CNT reads a TLB entry from the address translation table ATT in the main memory, the read TLB entry is stored in the TLB and also transmitted to the network interface control circuit. In response thereto, the control circuit stores the read TLB entry in the TLB storage portion TLB_2.

Subsequently, when DMA processing is executed as processing for reading a message from the main memory or writing a message to the main memory, the network interface control circuit NW_IF_CNT executes a TLB entry search on the TLB and the TLB storage portion TLB_2. The TLB storage portion TLB_2 stores only a small number of TLB entries, and therefore the search processing is completed quickly. After the search processing hits a hit in the TLB storage portion TLB_2, the network interface control circuit translates the virtual address into a real address using the hit TLB entry and then issues a message DMA request DMA_RQ to the DMA control circuit.

As described above in relation to the write packet or the read packet, TLB pre-caching is executed before executing processing for writing or reading a message to or from the main memory by DMA. Hence, when processing for writing or reading a message by DMA occurs, the TLB entry obtained by TLB pre-caching is stored in the TLB storage portion TLB_2, and therefore a hit can be expected in the TLB storage portion TLB_2. As a result, the latency of the DMA processing can be shortened.

According to the embodiments described above, firstly, the remote node pre-caching TLB is stored in the first packet, and therefore the network interface of the remote node executes TLB pre-caching while waiting to receive the following second packet. Hence, TLB pre-caching can be completed, or at least started, before the second packet is received without increasing the number of packets. As a result, the latency of internode message transfer can be shortened.

Secondly, the local node pre-caching TLB is stored in the first command so that the network interface of the local node executes TLB pre-caching while waiting to receive a write request command as the second command. Alternatively, the network interface executes TLB pre-caching while waiting to receive a response packet to the second packet (a read packet). Hence, TLB pre-caching can be completed, or at least started, before the second command or the response packet to the second packet (a read packet) is received without increasing the number of packets. As a result, the latency of internode message transfer can be shortened.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network interface device comprising:
a direct memory access control unit (referred to hereafter as a DMA) that accesses a main memory without passing through a processor;
an address translation buffer (referred to hereafter as a TLB) that stores address translation entries including a part of entries in an address translation table indicating correspondences between virtual addresses and real addresses, the address translation table being stored in the main memory; and
a control unit that controls processing in relation to a command transmitted from the processor and processing in relation to received transmission data, wherein:
the control unit,
upon reception from the processor of a first command including a first message inquiring as to the possibility of responding to a request for either writing or reading and a remote node pre-caching TLB, transmits first transmission data that include the first message and the remote node pre-caching TLB to a remote computer node, and
upon reception from the processor of a second command requesting either writing or reading, wherein the second command is issued in response to reception of first response data responded by the remote computer node to the first message and including a message indicating the possibility of responding to the request, and when the second command is a write request, transmits write transmission data that include a message including write data and a remote node virtual address both included in the second command to the remote computer node; and
the remote computer node,
in response to the first transmission data, reads a first address translation entry corresponding to the remote node pre-caching TLB from the main memory and pre-caches the read first address translation entry in the TLB, wherein the address translation entry includes a remote node real address of the main memory in the remote computer node corresponding to the remote node pre-caching TLB, and
in response to the write transmission data, translates the remote node virtual address into a remote node real address on the basis of the first address translation entry, and writes the write data to the main memory on the basis of the remote node real address.

2. The network interface device according to claim 1, wherein
the control unit,
upon reception of the first command, issues a pre-caching request, to the DMA, to read a second address translation entry corresponding to a local node pre-caching TLB included in the first command from the main memory and pre-cache the second address translation entry in the TLB, and
when the second command is a write request, translates a local node virtual address included in the second command into a local node real address on the basis of the second address translation entry and issues a read request, to the DMA, to read the write data from the main memory on the basis of the local node real address.

3. The network interface device according to claim 1, wherein,
the control unit,
when the second command is a read request, transmits read transmission data including the remote node virtual address included in the second command, and
the remote computer node,
in response to the read transmission data,
translates the remote node virtual address included in the read transmission data into a remote node real address on the basis of the first address translation entry and reads read data from the main memory on the basis of the remote node real address, and
transmits second response data including the read data to a local computer node.

4. The network interface device according to claim 2, wherein,
the control unit
when the second command is a read request, transmits read transmission data including the remote node virtual address included in the second command, and
the remote computer node,
in response to the read transmission data,
translates the remote node virtual address included in the read transmission data into a remote node real address on the basis of the first address translation entry and reads read data from the main memory on the basis of the remote node real address, and
transmits second response data including the read data to a local computer node.

5. The network interface device according to claim 4, wherein
the control unit,
upon reception of the second response data,
translates the local node virtual address included in the second command into a local node real address on the basis of the second address translation entry and
issues a write request, to the DMA, to write the read data to the main memory on the basis of the local node real address.

6. The network interface device according to claim 1, wherein
the remote computer node, in response to the first transmission data, issues a write request, to the DMA, to write the message included in the first transmission data to the main memory, and
the DMA in the remote computer node executes a first request to write the message to the main memory with a higher degree of priority than a second request to read the address translation entry from the main memory and pre-cache the read address translation entry in the TLB.

7. The network interface device according to claim 6, wherein
the DMA in the remote computer node
writes the message to the main memory by direct memory access in response to the first request, when the number of direct memory access operations currently underway has not reached a maximum value, and
reads the address translation entry from the main memory by direct memory access in response to the second request, when the number of direct memory access operations currently underway has not reached a number that is smaller than the maximum value by a predetermined number.

8. The network interface device according to claim 1, wherein
the control unit includes a TLB storage portion that stores a part of the address translation entries in the TLB, and
when reading a message from the main memory or writing a message to the main memory, the control unit executes a TLB entry search on the TLB storage portion.

9. An information processing device comprising:
a local computer node that includes a network interface; and
a remote computer node that includes a network interface and is able to communicate with the local computer through a network; wherein
the network interfaces of the local computer node and the remote computer node each includes
a direct memory access control unit (referred to hereafter as a DMA) that accesses a main memory without passing through a processor;
an address translation buffer (referred to hereafter as a TLB) that stores address translation entries including a part of entries in an address translation table indicating correspondences between virtual addresses and real addresses, the address translation table being stored in the main memory; and
a control unit that controls processing in relation to a command transmitted from the processor and processing in relation to received transmission data, wherein:
the control unit in the local computer node,
upon reception from the processor of a first command including a first message inquiring as to the possibility of responding to a request for either writing or reading and a remote node pre-caching TLB, transmits first transmission data that include the first message and the remote node pre-caching TLB to a remote computer node, and
upon reception from the processor of a second command requesting either writing or reading, wherein the second command is issued in response to reception of first response data responded by the remote computer node to the first message and including a message indicating the possibility of responding to the request, and when the second command is a write request, transmits write transmission data that include a message including write data and a remote node virtual address both included in the second command to the remote computer node; and
the control unit in the remote computer node,
in response to the first transmission data, reads a first address translation entry corresponding to the remote node pre-caching TLB from the main memory and pre-caches the read first address translation entry in the TLB, wherein the address translation entry includes a remote node real address of the main memory in the remote computer node corresponding to the remote node pre-caching TLB, and
in response to the write transmission data, translates the remote node virtual address into a remote node real address on the basis of the first address translation entry, and writes the write data to the main memory on the basis of the remote node real address.

10. A method of transmitting data between nodes of an information processing device, the method comprising:
the information processing device including
a local computer node that includes a network interface; and
a remote computer node that includes a network interface and is able to communicate with the local computer through a network;
the network interfaces of the local computer node and the remote computer node each including
a direct memory access control unit (referred to hereafter as a DMA) that accesses a main memory without passing through a processor;
an address translation buffer (referred to hereafter as a TLB) that stores address translation entries including a part of entries in an address translation table indicating correspondences between virtual addresses and real addresses, the address translation table being stored in the main memory; and
a control unit that controls processing in relation to a command transmitted from the processor and processing in relation to received transmission data,
the control unit in the local computer node,
upon reception from the processor of a first command including a first message inquiring as to the possibility of responding to a request for either writing or reading and a remote node pre-caching TLB, transmitting first transmission data that include the first message and the remote node pre-caching TLB to a remote computer node, and
upon reception from the processor of a second command requesting either writing or reading, wherein the second command is issued in response to reception of first response data responded by the remote computer node to the first message and including a message indicating the possibility of responding to the request, and when the second command is a write request, transmitting write transmission data that include a message including write data and a remote node virtual address both included in the second command to the remote computer node; and
the control unit in the remote computer node,
in response to the first transmission data, reading a first address translation entry corresponding to the remote node pre-caching TLB from the main memory and pre-caches the read first address translation entry in the TLB, wherein the address translation entry includes a remote node real address of the main memory in the remote computer node corresponding to the remote node pre-caching TLB, and
in response to the write transmission data, translating the remote node virtual address into a remote node real address on the basis of the first address translation entry, and writing the write data to the main memory on the basis of the remote node real address.
